(19) United States
(12) Patent Application Publication
(10) Pub. No.: US 2025/0054375 A1
(43) Pub. Date: Feb. 13, 2025

(54) TECHNIQUES FOR ATM MANAGEMENT

(71) Applicant: JHAT Development LLC, Bountiful, UT (US)

(72) Inventor: Jeremiah Chesley, North Salt Lake, UT (US)

(21) Appl. No.: 18/801,270

(22) Filed: Aug. 12, 2024

Related U.S. Application Data
(60) Provisional application No. 63/532,244, filed on Aug. 11, 2023.

(51) Int. Cl. G07F 19/00; H04L 9/40

(52) U.S. Cl. CPC G07F 19/209; H04L 63/08

(57) ABSTRACT

Apparatuses, methods, systems, and program products are disclosed for ATM management. An apparatus is configured to determine identifying information for an automated teller machine (ATM) that is being managed, determine a service script for the ATM, the service script comprising information for maintaining the ATM, identify multimedia elements associated with the information in the service script, and present the service script and the associated multimedia elements on an end user device.

### CROSS-REFERENCE TO RELATED APPLICATIONS

This application claims the benefit of U.S. Provisional Patent Application No. 63/532,244 entitled TECHNIQUES FOR ATM MANAGEMENT and filed on Aug. 11, 2023, for Jeremiah Chesley, which is incorporated herein by reference.

### FIELD

The subject matter disclosed herein relates to automated teller machines (“ATMs”) and more particularly relates to techniques for ATM management.

### BACKGROUND

An ATM may refer to an electronic banking outlet that allows customers to complete basic transactions without the aid of a branch representative or teller. ATMs may require periodic service to maintain the physical appearance of the ATM, to maintain the mechanics, components, and other parts of the ATM, or the like. In such an embodiment, service technicians may perform various maintenance tasks associated with an ATM. The service technicians may perform routine service checks, maintenance tasks, or more complex repairs.

### SUMMARY

Apparatuses, methods, systems, and program products are disclosed for ATM management. An apparatus, in one embodiment, is configured to determine identifying information for an ATM that is being managed, determine a service script for the ATM, the service script comprising information for maintaining the ATM, identify multimedia elements associated with the information in the service script, and present the service script and the associated multimedia elements on an end user device.

A method, in one embodiment, includes determining identifying information for an ATM that is being managed, determining a service script for the ATM, the service script comprising information for maintaining the ATM, identifying multimedia elements associated with the information in the service script, and presenting the service script and the associated multimedia elements on an end user device.

In one embodiment, a computer program product is configured to determine identifying information for an ATM that is being managed, determine a service script for the ATM, the service script comprising information for maintaining the ATM, identify multimedia elements associated with the information in the service script, and present the service script and the associated multimedia elements on an end user device.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 illustrates an example of a system providing techniques for ATM management in accordance with the subject matter disclosed herein;

FIG. 2 illustrates one embodiment of an apparatus for ATM management in accordance with the subject matter disclosed herein;

FIG. 3 illustrates one embodiment of an apparatus for ATM management in accordance with the subject matter disclosed herein;

FIG. 4 illustrates one embodiment of a method for ATM management in accordance with the subject matter disclosed herein;

FIG. 5 illustrates one embodiment of a method for ATM management in accordance with the subject matter disclosed herein;

FIG. 6 illustrates one embodiment of a method for ATM management in accordance with the subject matter disclosed herein.

### DETAILED DESCRIPTION

As will be appreciated by one skilled in the art, aspects of the embodiments may be embodied as a system, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Apparatuses, methods, systems, and program products are disclosed for ATM management. An apparatus, in one embodiment, is configured to determine identifying information for an ATM that is being managed, determine a service script for the ATM, the service script comprising information for maintaining the ATM, identify multimedia elements associated with the information in the service script, and present the service script and the associated multimedia elements on an end user device.

In one embodiment, the service script comprises a series of predefined steps for performing maintenance on the ATM. In one embodiment, the multimedia elements comprise images, videos, links to external resources, or a combination thereof, for at least one of the series of predefined steps.

In one embodiment, the apparatus is configured to cause the apparatus to receive input from the end user device for the service script. In one embodiment, the input comprises text input, image input, video input, audio input, or a combination thereof associated with maintenance of the ATM.

In one embodiment, the apparatus is configured to cause the apparatus to periodically verify a quality of the input. In one embodiment, the input is provided to an artificial intelligence engine for performing at least one quality control check of the input.

In one embodiment, the apparatus is configured to provide the input to a third party. In one embodiment, the apparatus is configured to provide a gateway for accessing information about an ATM, including the identifying information for the ATM.

In one embodiment, the apparatus is configured to receive user credentials from the gateway for authenticating the user, the user credentials determining access permissions for a user. In one embodiment, the apparatus is configured to present a plurality of ATMs that are being managed and information for the plurality of ATMs based on the permissions for the user.

In one embodiment, the apparatus is configured to receive a selection of one of the plurality of ATMs and present additional information for the selected one of the plurality of ATMs. In one embodiment, the apparatus is configured to receive filter criteria for filtering the plurality of ATMs. In one embodiment, the apparatus is configured to create custom categories for the plurality of ATMs based on user input.

In one embodiment, the apparatus is configured to arrange the plurality of ATMs according to a priority based on maintenance needs. In one embodiment, the apparatus is configured to visually highlight the plurality of ATMs according to the priority.

In one embodiment, the apparatus is configured to send a message to a user associated with the ATM, the message comprising an image of the ATM, a description of the ATM, a service history of the ATM, or a combination thereof. In one embodiment, the apparatus is configured to send a message in response to an ATM having a critical issue.

A method, in one embodiment, includes determining identifying information for an ATM that is being managed, determining a service script for the ATM, the service script comprising information for maintaining the ATM, identifying multimedia elements associated with the information in the service script, and presenting the service script and the associated multimedia elements on an end user device.

In one embodiment, a computer program product is configured to determine identifying information for an ATM that is being managed, determine a service script for the ATM, the service script comprising information for maintaining the ATM, identify multimedia elements associated with the information in the service script, and present the service script and the associated multimedia elements on an end user device.

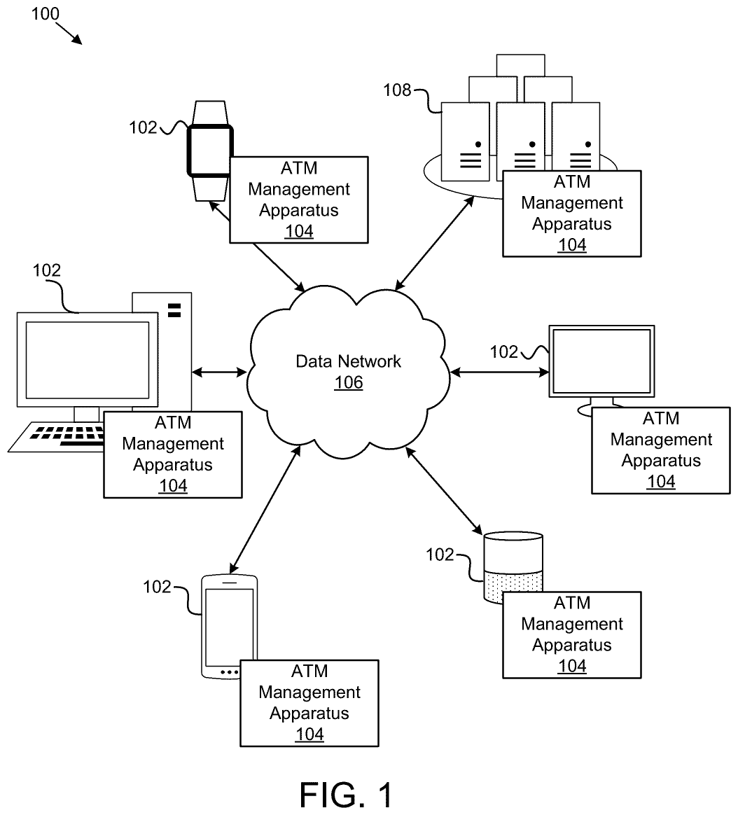

FIG. 1 is a schematic block diagram illustrating one embodiment of a system 100 for ATM management. In one embodiment, the system 100 includes one or more information handling devices 102, one or more ATM management apparatuses 104, one or more data networks 106, and one or more servers 108. In certain embodiments, even though a specific number of information handling devices 102, ATM management apparatuses 104, data networks 106, and servers 108 are depicted in FIG. 1, one of skill in the art will recognize, in light of this disclosure, that any number of information handling devices 102, ATM management apparatuses 104, data networks 106, and servers 108 may be included in the system 100.

In one embodiment, the system 100 includes one or more information handling devices 102. The information handling devices 102 may be embodied as one or more of a desktop computer, a laptop computer, a tablet computer, a smart phone, a smart speaker (e.g., Amazon Echo®, Google Home®, Apple HomePod®), an ATM, an Internet of Things device, a security system, a set-top box, a gaming console, a smart TV, a smart watch, a fitness band or other wearable activity tracking device, an optical head-mounted display (e.g., a virtual reality headset, smart glasses, or the like), a High-Definition Multimedia Interface (“HDMI”) or other electronic display dongle, a personal digital assistant, a digital camera, a video camera, an in-car computing device, a navigation system, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

In one embodiment, the ATM management apparatus 104 provides processes, interfaces, algorithms, and/or the like for remote management, inventory, tracking, maintenance, and servicing of ATMs. As used herein, an ATM may refer to an electronic banking outlet that allows customers to complete basic transactions without the aid of a branch representative or teller. ATMs may require periodic service to maintain the physical appearance of the ATM, to maintain the mechanics, components, and other parts of the ATM, or the like. In such an embodiment, service technicians may perform various maintenance tasks associated with an ATM. The service technicians may perform routine service checks, maintenance tasks, or more complex repairs.

In one embodiment, the ATM management apparatus 104 may provide a program, application (e.g., a mobile application), or the like, that provides details about an ATM that the service technician is servicing. The information may include a service history or other maintenance records, model specifications, age of the ATM, and/or the like.

In certain embodiments, the ATM management apparatus 104 may include a hardware device such as a secure hardware dongle or other hardware appliance device (e.g., a set-top box, a network appliance, or the like) that attaches to a device such as a laptop computer, a server 108, a tablet computer, a smart phone, a security system, a network router or switch, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like.

A hardware appliance of the ATM management apparatus 104 may include a power interface, a wired and/or wireless network interface, a graphical interface that attaches to a display, and/or a semiconductor integrated circuit device as described below, configured to perform the functions described herein with regard to the ATM management apparatus 104.

The ATM management apparatus 104, in such an embodiment, may include a semiconductor integrated circuit device (e.g., one or more chips, die, or other discrete logic hardware), or the like, such as an FPGA or other programmable logic, firmware for an FPGA or other programmable logic, microcode for execution on a microcontroller, an ASIC, a processor, a processor core, or the like.

In one embodiment, the ATM management apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the ATM management apparatus 104.

The semiconductor integrated circuit device or other hardware appliance of the ATM management apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the ATM management apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”) (e.g., a home network), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102 and may host, store, stream, or the like applications, files, multimedia, and/or other content.

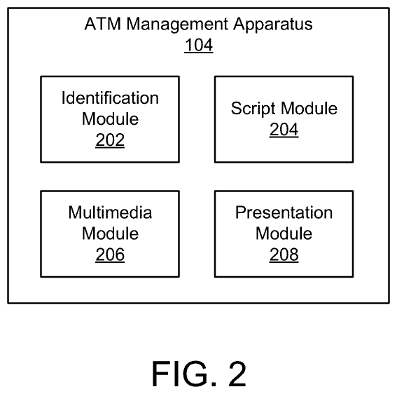

FIG. 2 depicts one embodiment of an apparatus for ATM management. In one embodiment, the apparatus includes an instance of an ATM management apparatus 104. In one embodiment, the ATM management apparatus 104 includes one or more of an identification module 202, a script module 204, a multimedia module 206, and a presentation module 208, which are described below.

In one embodiment, the identification module 202 is configured to determine identifying information for an ATM that is being managed. The identification information may include a model number, serial number, location, name, unique identifier, and/or the like. In one embodiment, the identification module 202 may reference a database, online resource, list, file, or the like for the identification information.

In one embodiment, the script module 204 is configured to provide a service script to a service technician for servicing an ATM. As used herein, a service script may refer to a list of steps, items, mechanisms, components, parts, and/or the like to be performed, to be checked, to be serviced, and/or the like during a service check of an ATM. In certain embodiments, the script module 204 presents information for each step of the service script, which may include instructions, videos, audio, images, links to websites, and/or the like for performing the step.

In such an embodiment, the multimedia module 206 is configured to identify, access, download, integrate, or the like multimedia content into the service script. The multimedia content may include videos, images, slideshows, links to websites, audio, and/or the like that help assist a user to perform one or more steps of the script for maintaining an ATM. For example, the multimedia module 206 may integrate an instructional video, or provide a link to a YouTube video, that explains how to perform one or more steps of the service script.

In one embodiment, the presentation module 208 is configured to present the service script and the associated multimedia elements on an end user device. The end user device, for example, may be a smart phone or tablet device that a service technician uses to perform the maintenance on the ATM. The presentation module 208 may provide a graphical interface that allows playback or display of multimedia elements in addition to the steps of the service script. The presentation module 208 may also display additional information for a step of the service script such as links to external sites; phone numbers, links, chat services, or other contact information for the manufacturer; recent news or information regarding the ATM being maintained (e.g., recall or service history information); and/or the like.

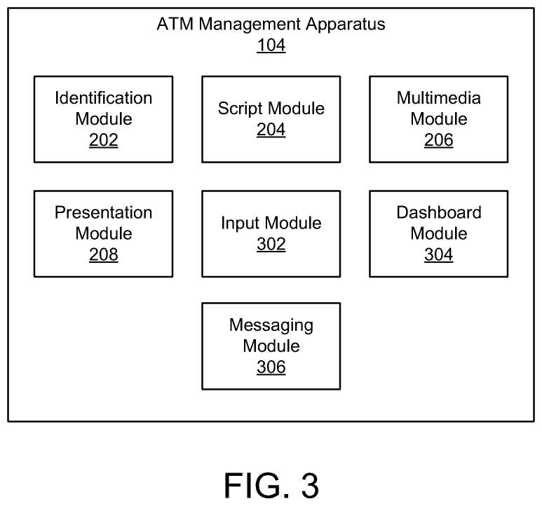

FIG. 3 depicts one embodiment of an apparatus for ATM management. In one embodiment, the apparatus includes an instance of an ATM management apparatus 104. In one embodiment, the ATM management apparatus 104 includes one or more of an identification module 202, a script module 204, a multimedia module 206, and a presentation module 208, described above with reference to FIG. 2. In one embodiment, the ATM management apparatus 104 includes one or more of an input module 302, a dashboard module 304, and a messaging module 306, which are described below.

In one embodiment, the input module 302 is configured to provide means for receiving input from the service technician such as text input (e.g., for describing the service/checks that were performed), multimedia content (e.g., images of the ATM or the ATM part that is being serviced, video of the service being performed, and/or the like). In certain embodiments, the input module 302 communicates with, integrates with, or otherwise interacts with input components (e.g., a virtual keyboard, a camera, or the like) on the service technician's device (e.g., a smart phone, a tablet computer, or the like) to capture, obtain, or otherwise receive input associated with the step of the service script. In one embodiment, the information/data received during the service/maintenance check of the ATM is uploaded, stored, or otherwise saved in a database or other data store.

In one embodiment, the input module 302 periodically or continually runs quality control services or processes on the database to verify the data, e.g., verify that the data is accurate, up to date, is of an expected type, and/or the like. For example, the input module 302 may verify that a description of the service that was performed matches images or video of the ATM that was uploaded during the service. In certain embodiments, the input module 302 runs quality control checks on the data prior to publishing or otherwise making the data/information available to a third party, e.g., a vendor, financial institution, or the like.

In one embodiment, the input module 302 provides data in the database as input to artificial intelligence/machine learning, which is trained and used to perform quality control functions. As used herein, artificial intelligence (“AI”) is broadly defined as a branch of computer science dealing in automating intelligent behavior. AI systems may be designed to use machines to emulate and simulate human intelligence and corresponding behavior. This may take many forms, including symbolic or symbol manipulation AI. AI may address analyzing abstract symbols and/or human readable symbols. AI may form abstract connections between data or other information or stimuli. AI may form logical conclusions. AI is the intelligence exhibited by machines, programs, or software. AI has been defined as the study and design of intelligent agents, in which an intelligent agent is a system that perceives its environment and takes actions that maximize its chances of success.

AI may have various attributes such as deduction, reasoning, and problem solving. AI may include knowledge representation or learning. AI systems may perform natural language processing, perception, motion detection, and information manipulation. At higher levels of abstraction, it may result in social intelligence, creativity, and general intelligence. Various approaches are employed including cybernetics and brain simulation, symbolic, sub-symbolic, and statistical, as well as integrating the approaches.

Various AI tools may be employed, either alone or in combinations. The tools may include search and optimization, logic, probabilistic methods for uncertain reasoning, classifiers and statistical learning methods, neural networks, deep feedforward neural networks, deep recurrent neural networks, deep learning, control theory and languages.

In one embodiment, the ATM management apparatus 104 utilizes a generative AI engine/model that accepts prompts such as questions, queries, or the like and provides responses to the prompts. In this case, the ATM management apparatus 104 may provide prompts related to ATMs, such as “Which ATMs have been serviced to John Doe in the last 3 years?,” “How accurate is the input related to this ATM?,” “How often are ATMs with this model number serviced?,” or the like, and the generative AI engine/model performs various AI functions on the data to determine the result. In such an embodiment, the AI engine/model may be specially trained on the ATM data, such as service history data, ATM model data, ATM technician data, and/or the like. The AI engine/model may be continually trained in response to new data being input and stored in a database.

Machine learning (“ML”) plays an important role in a wide range of critical applications with large volumes of data, such as data mining, natural language processing, image recognition, voice recognition and many other intelligent systems. There are some basic common threads about the definition of ML. As used herein, ML is defined as the field of study that gives computers the ability to learn without being explicitly programmed. For example, predicting traffic patterns at a busy intersection, it is possible to run through a machine learning algorithm with data about past traffic patterns. The program can correctly predict future traffic patterns if it learned correctly from past patterns.

In one embodiment, the input module 302 maintains data within the database according to a data retention policy. In certain embodiments, the data retention policy may specify that a client's data (e.g., a financial institution's ATM data) is live and available to the client during a contract period for the client. Thus, the input module 302 may provide historical ATM data to a client such as the service or maintenance record, for the lifetime of the ATM, for a defined time period/range, and/or the like.

In one embodiment, the dashboard module 304 provides a remote interface, e.g., a graphical user interface (dashboard), an application programming interface (“API”), a command line interface (“CLI”), or the like for accessing information about ATMs. In one embodiment, the dashboard module 304 provides an interface for an owner, lessee, licensor, manager, administrator, or the like of an ATM. In such an embodiment, the dashboard module 304 may authenticate the user, e.g., using credentials, biometrics, or the like, and if successfully authorized, check the access level, clearance level, security level, authorization level, permission level, or the like of the user.

Based on the determined access level, the dashboard module 304 determines which information the user is authorized to access and/or view. In such an embodiment, the dashboard module 304 may present a list of ATMs, images of ATMs, descriptive information about the ATMs, and/or the like to the user. In further embodiments, the dashboard module 304 may present thumbnail images, or other selectable links, of the ATMs that the user can click, tap, or otherwise interact with to view additional information about the ATM such as service history, age, model, specifications, location, and/or the like.

In some embodiments, the dashboard module 304 provides a filter mechanism e.g., a search box or a drop down with predefined ATM characteristics that a user can use to filter the ATM list to ATMs of interest. For example, the dashboard module 304 may display ATMs that are associated with a location or geographic region, that are made by a particular manufacturer, ATMs that have been serviced within a defined time period, ATMs that have certain defined specifications, ATMs of a particular model, ATMs that were manufactured or installed within a certain time period, ATMs that match the provided keywords/search terms, ATMs with particular characteristics (e.g., a braille keypad or decal), ATMs with known issues, ATMs with particular types of issues, and/or the like.

In one embodiment, the dashboard module 304 allows a user to create custom categories for searching, arranging, filtering, or otherwise organizing the presented ATMs, e.g., based on results of a search or filter, based on user-defined parameters or variables, user-selected ATMs, and/or the like. For example, categories may include customer branding that presents information regarding the state of company branding on their associated ATMs; a customer experience category may present information regarding the state of the customer-facing components of the ATM (e.g., the keypad, the monitor, the cleanliness of the ATM, and/or the like); a security category that presents information regarding the state of the physical security of the ATM; and/or the like.

In certain embodiments, the dashboard module 304 may categorize, prioritize, highlight, arrange, or otherwise call out ATMs that have known issues, service/maintenance needs, or the like. For example, the dashboard module 304 may visually present ATMs with critical issues near the top of the list; may highlight ATMs with critical issues in red, bold text, blinking text; and/or the like. Other styles may be used to visually emphasize notices, notifications, issues, and/or the like associated with different ATMs.

In certain embodiments, the messaging module 306 provides means for sending a message to a colleague, service technician, administrator, vendor, and/or other contact via the interface. For instance, the messaging module 306 may provide messaging services to allow an administrator to email an ATM vendor, text or instance message a service technician, and/or the like. In certain embodiments, the messaging module 306 may automatically attach an image or the ATM, a description of the ATM, service history of the ATM, and/or other descriptive information associated with the ATM to the electronic message.

In such an embodiment, the messaging module 306 automatically sends (to an administrator or other authorized person) an electronic alert, message, notification, and/or the like of critical issues, time-sensitive issues, and/or the like. In one embodiment, critical or high priority issues (or other issues/parameters that are defined as needing a notification/alert) may be defined based on customer/client preferences, schema, definitions, policy, and/or the like.

In one embodiment, the ATM management apparatus 104 interacts, interfaces, or otherwise communicates with a manufacturer or other system (e.g., via an API) to remotely manage or control different components or functions of an ATM. For example, the ATM management apparatus 104 may remotely communicate directly with an ATM, or via an ATM manufacturer's system, to reboot the ATM, to change monitor properties (e.g., update the interface), push updates or commands to the ATM, and/or the like.

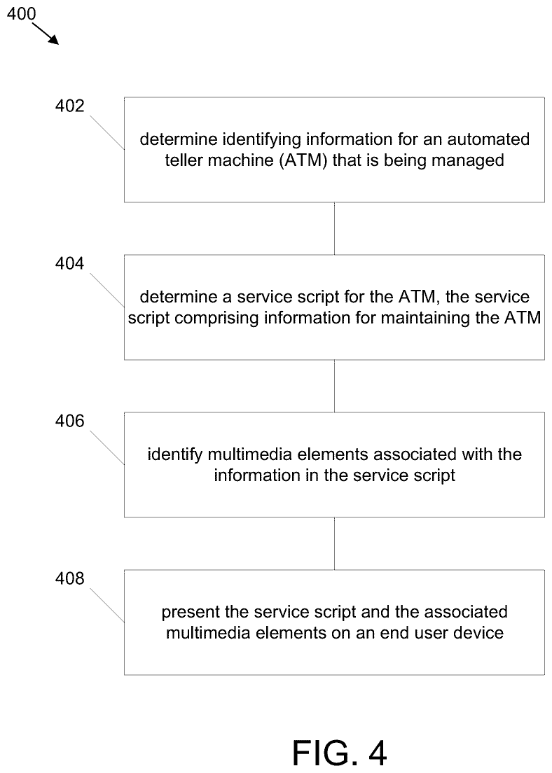

FIG. 4 depicts one embodiment of a method for ATM management. In one embodiment, the method 400 is performed by a processor, an FPGA, an application, a server, an end user device, a cloud device, an ATM management apparatus 104, an identification module 202, a script module 204, a multimedia module 206, a presentation module 208, an input module 302, a dashboard module 304, a messaging module 306, and/or the like.

In one embodiment, the method 400 begins and determines 402 identifying information for an ATM that is being managed. In one embodiment, the method 400 determines 404 a service script for the ATM, the service script comprising information for maintaining the ATM. In one embodiment, the method 400 identifies 406 multimedia elements associated with the information in the service script. In one embodiment, the method 400 presents 408 the service script and the associated multimedia elements on an end user device, and the method 400 ends.

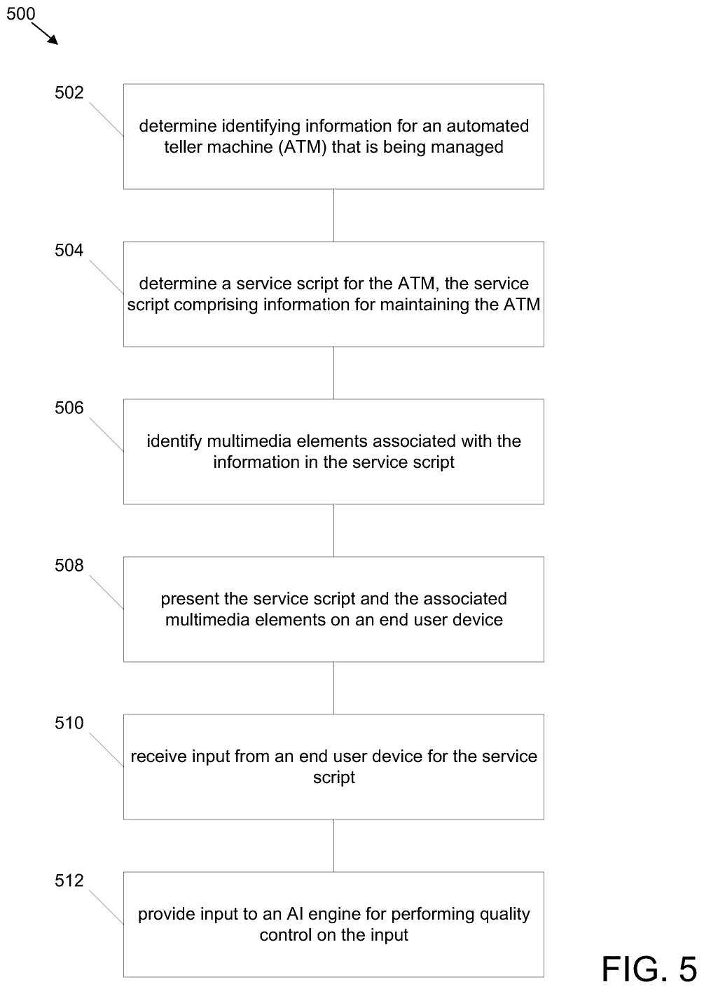

FIG. 5 depicts one embodiment of a method for ATM management. In one embodiment, the method 500 is performed by a processor, an FPGA, an application, a server, an end user device, a cloud device, an ATM management apparatus 104, an identification module 202, a script module 204, a multimedia module 206, a presentation module 208, an input module 302, a dashboard module 304, a messaging module 306, and/or the like.

In one embodiment, the method 500 begins and determines 502 identifying information for an ATM that is being managed. In one embodiment, the method 500 determines 504 a service script for the ATM, the service script comprising information for maintaining the ATM. In one embodiment, the method 500 identifies 506 multimedia elements associated with the information in the service script. In one embodiment, the method 500 presents 508 the service script and the associated multimedia elements on an end user device.

In one embodiment, the method 500 receives 510 input from an end user device (e.g., a service technician's device) for the service script, such as service information, images, videos, and/or the like. In one embodiment, the method 500 provides 512 input to an AI engine for performing quality control on the input, e.g., to check the veracity or soundness of the input, and the method 500 ends.

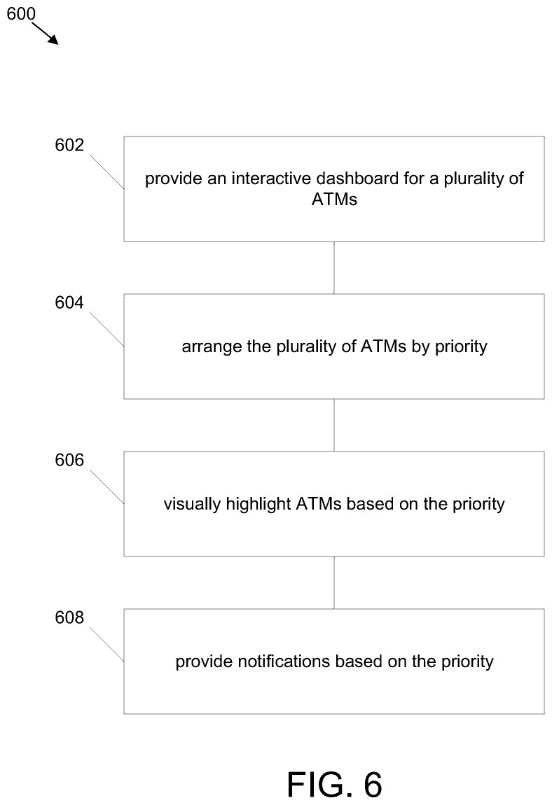

FIG. 6 depicts one embodiment of a method for ATM management. In one embodiment, the method 600 is performed by a processor, an FPGA, an application, a server, an end user device, a cloud device, an ATM management apparatus 104, an identification module 202, a script module 204, a multimedia module 206, a presentation module 208, an input module 302, a dashboard module 304, a messaging module 306, and/or the like.

In one embodiment, the method 600 begins and provides 602 an interactive dashboard for a plurality of ATMs. The dashboard may be graphical interface showing information for a plurality of ATMs, such as images, data, service history, or the like. In one embodiment, the method 600 arranges 604 the plurality of ATMs by priority. The priority may be based on service deadlines, errors, issues, and/or the like.

In one embodiment, the method 600 visually highlights 606 ATMs based on the priority. For instance, ATMs with critical issues or overdue service deadlines may be highlighted in red or may blink. In one embodiment, the method 600 provides 608 notification based on the priority, such as alerts, error notifications, or the like, and the method 600 ends.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
at least one memory; and
at least one processor coupled to the at least one memory and configured to cause the apparatus to:
determine identifying information for an automated teller machine (ATM) that is being managed;
determine a service script for the ATM, the service script comprising information for maintaining the ATM;
identify multimedia elements associated with the information in the service script; and
present the service script and the associated multimedia elements on an end user device.

2. The apparatus of claim 1, wherein the service script comprises a series of predefined steps for performing maintenance on the ATM.

3. The apparatus of claim 2, wherein the multimedia elements comprise images, videos, links to external resources, or a combination thereof, for at least one of the series of predefined steps.

4. The apparatus of claim 1, wherein the at least one processor is configured to cause the apparatus to receive input from the end user device for the service script.

5. The apparatus of claim 4, wherein the input comprises text input, image input, video input, audio input, or a combination thereof associated with maintenance of the ATM.

6. The apparatus of claim 4, wherein the at least one processor is configured to cause the apparatus to periodically verify a quality of the input.

7. The apparatus of claim 6, wherein the input is provided to an artificial intelligence engine for performing at least one quality control check of the input.

8. The apparatus of claim 4, wherein the at least one processor is configured to cause the apparatus to provide the input to a third party.

9. The apparatus of claim 1, wherein the at least one processor is configured to cause the apparatus to provide a gateway for accessing information about an ATM, including the identifying information for the ATM.

10. The apparatus of claim 9, wherein the at least one processor is configured to cause the apparatus to receive user credentials from the gateway for authenticating a user, the user credentials determining access permissions for a user.

11. The apparatus of claim 10, wherein the at least one processor is configured to cause the apparatus to present a plurality of ATMs that are being managed and information for the plurality of ATMs based on the permissions for the user.

12. The apparatus of claim 11, wherein the at least one processor is configured to cause the apparatus to receive a selection of one of the plurality of ATMs and present additional information for the selected one of the plurality of ATMs.

13. The apparatus of claim 11, wherein the at least one processor is configured to cause the apparatus to receive filter criteria for filtering the plurality of ATMs.

14. The apparatus of claim 11, wherein the at least one processor is configured to cause the apparatus to create custom categories for the plurality of ATMs based on user input.

15. The apparatus of claim 11, wherein the at least one processor is configured to cause the apparatus to arrange the plurality of ATMs according to a priority based on maintenance needs.

16. The apparatus of claim 15, wherein the at least one processor is configured to cause the apparatus to visually highlight the plurality of ATMs according to the priority.

17. The apparatus of claim 1, wherein the at least one processor is configured to cause the apparatus to send a message to a user associated with the ATM, the message comprising an image of the ATM, a description of the ATM, a service history of the ATM, or a combination thereof.

18. The apparatus of claim 17, wherein the at least one processor is configured to cause the apparatus to send a message in response to an ATM having a critical issue.

19. A method, comprising:
determining identifying information for an automated teller machine (ATM) that is being managed;
determining a service script for the ATM, the service script comprising information for maintaining the ATM;
identifying multimedia elements associated with the information in the service script; and
presenting the service script and the associated multimedia elements on an end user device.

20. A computer program product comprising a non-transitory computer readable storage medium storing code, the code being configured to be executable by a processor to perform operations comprising:
determining identifying information for an automated teller machine (ATM) that is being managed;
determining a service script for the ATM, the service script comprising information for maintaining the ATM;
identifying multimedia elements associated with the information in the service script; and
presenting the service script and the associated multimedia elements on an end user device.
